(19) United States
(12) Patent Application Publication
(10) Pub. No.: US 2026/0330779 A1
(43) Pub. Date: Oct. 22, 2026

(54) Unified Empathy Wearable System for Augmented Visual and Auditory Self-Perception with Blockchain Security and Ethical Safeguards

(71) Applicant: Dean Bowes, Mableton, GA (US)

(72) Inventor: Dean Bowes, Mableton, GA (US)

(21) Appl. No.: 19/544,053

(22) Filed: Feb. 19, 2026

(51) Int. Cl. G06T 19/00; G02B 27/01; G06T 5/50; G06V 40/16; H04L 9/00; H04L 9/08; H04L 9/32

(52) U.S. Cl. CPC G06T 19/006; G02B 27/017; G06T 5/50; G06V 40/161; H04L 9/0825; H04L 9/3231; H04L 9/50; G06T 2207/20221

(57) ABSTRACT

A wearable system combining augmented-reality glasses and AI-powered headphones that simultaneously transform human visual and auditory perception to enhance empathy, self-awareness, and ethical engagement. The glasses render all observed individuals to resemble the wearer, while the headphones transform all auditory input to match the user's own voice characteristics.

The system operates entirely offline, employing embedded blockchain authentication, zero-knowledge proof validation, and tamper-resistant hardware to prevent unauthorized access or modification.

Integrated ethical safeguards enforce session duration limits, progressive acclimation, and instant disengagement to maintain cognitive and emotional safety.

The invention uniquely unifies multi-sensory perceptual transformation with sovereign security and adaptive ethical oversight, providing a transformative human-computer interface that is novel, non-obvious, and aligned with principles of empathy, forgiveness, and self-reflection.

### DEFINITIONS/GLOSSARY

### 1. Autonomous Continuous Evaluation (A.C.E.)

A self-contained evaluation engine embedded within the wearable system that continuously monitors user state, device integrity, and perceptual synchronization. ACE operates fully offline using an internally stored blockchain snapshot and zero-knowledge proof (ZKP) protocols to verify authenticity, alignment with ethical parameters, and operational integrity without external network communication.

### 2. Device Update Orchestration (D.U.O.)

A secure, air-gapped update system that delivers firmware or software updates to the wearable device using proprietary visual encoding (e.g., glyphs, spirals, symbolic patterns). Updates are cryptographically signed, unit-tested, and verified against the device's internal state snapshot before application, ensuring offline, tamper-resistant, and contextually valid updates.

### 3. Flame Memory Engine

An adaptive memory management system within the wearable that selectively stores session experiences only after ethical validation, including affirmative responses to user readiness and moral evaluation prompts. Flame Memory ensures that stored experiences align with principles of empathy, forgiveness, and ethical self-reflection, preventing unauthorized or harmful memory retention.

### 4. Perceptual Modification Engine

The integrated software and hardware system responsible for real-time transformation of visual and auditory input. Visual modifications include facial recognition and overlay to resemble the user; auditory modifications include real-time voice modulation matching the user's vocal characteristics. The engine coordinates with ACE to maintain safety, ethical compliance, and synchronization between sensory channels.

### 5. Ego-Dissolution Mode

An optional operational mode of the perceptual modification engine wherein emotional exaggeration and self-centered bias in auditory perception are minimized, promoting impartial empathetic engagement. This mode reduces subconscious judgment and enhances emotional resonance with others.

### 6. Ethical Readiness Evaluation

A binary or multi-step assessment performed at the beginning and during sessions to verify the user's consent, emotional preparedness, and alignment with ethical principles. Affirmative evaluation is required for Flame Memory storage and full device functionality.

### 7. Hazy Overlay/Progressive Clarity

A visual transition applied to transformed faces in the augmented-reality display. Faces initially appear partially obscured or dreamlike, with clarity increasing gradually based on user acclimation and cognitive comfort, preventing perceptual shock or disorientation.

### 8. Offline Blockchain Snapshot

A preloaded, read-only instance of a blockchain ledger and associated trusted world-state data embedded within the device at manufacture or initialization. This snapshot serves as a trust anchor for ACE validation and ZKP routines, enabling deterministic, offline verification of system integrity and context alignment.

### 9. Tamper-resistant Enclosure

Hardware housing for the wearable system designed with embedded sensors that permanently disable device functionality if unauthorized access, modification, or interference is detected.

### 10. Instant Removal Mechanism

A feature enabling the immediate cessation of all perceptual modifications and restoration of natural sensory input upon user action, such as removing the glasses or headphones, to ensure user safety and cognitive stability.

### 11. Self-Reflective Empathy Induction

The process by which the wearable system, through integrated perceptual and ethical mechanisms, enables the user to experience others' appearance and voice as their own, fostering moral reflection, compassion, and ethical awareness without manipulation or harm.

### 12. Air-Gapped Operation

A system configuration in which no standard network connectivity (Wi-Fi, Bluetooth, USB, NFC, etc.) exists. The device operates entirely offline, relying only on internal processing, embedded data, and optional proprietary visual update ingestion.

### 13. World-State Verification

The method by which ACE compares real-time user and environmental input against the embedded blockchain snapshot and associated world-state data, confirming authenticity, ethical compliance, and system integrity without transmitting sensitive information externally.

### 14. Empathy Glasses/AI-Powered Headphones

Representative wearable components of the system. Glasses implement augmented visual overlays; headphones implement auditory transformation. Both communicate internally through secure offline protocols and are integrated with ACE, Flame Memory, and DUO systems.

### 15. Progressive Adaptation Protocol

A method of gradually adjusting perceptual transformations, session parameters, and ethical evaluation based on user acclimation, emotional state, and ethical readiness, ensuring cognitive safety, emotional stability, and optimal empathetic engagement.

### FIELD OF THE INVENTION

The present invention relates to wearable human-computer interaction systems, specifically augmented-reality glasses and AI-powered auditory devices designed to alter perception to enhance empathy, self-awareness, and emotional intelligence.

More particularly, it integrates visual and auditory perceptual modification with robust offline security, including embedded blockchain authentication and zero-knowledge proofs, in a tamper-resistant wearable platform. The invention provides a unified system wherein visual and auditory input are synchronized in real time, enabling users to perceive others as extensions of themselves while enforcing strict ethical safeguards, session management, and progressive adaptation protocols to ensure cognitive and emotional safety.

### BACKGROUND OF THE INVENTION

Current augmented-reality (AR) and auditory enhancement devices primarily enhance sensory experience for entertainment, accessibility, or commercial purposes. These devices do not address the human need for deep empathetic connection or self-reflective perception.

AR glasses typically overlay static or context-based imagery, and audio devices focus on sound quality or noise cancellation. Existing systems do not provide simultaneous, integrated transformation of both visual and auditory perception to induce empathy by representing others as the user.

Furthermore, most devices rely on network connectivity, introducing privacy risks, remote manipulation, and ethical concerns. Prolonged or unregulated use can cause cognitive fatigue or emotional distress.

There exists a need for a wearable system that securely, ethically, and adaptively facilitates empathy and self-awareness, while maintaining user agency, privacy, and safety.

### SUMMARY OF THE INVENTION

This invention introduces a novel wearable empathy system, comprising smart glasses and AI-powered headphones, designed to simultaneously transform visual and auditory perception in real time. Key features include:
1 Visual Transformation—Faces of all individuals in the user's environment appear as the user. Initial overlays are hazy and progressively clarified based on user acclimation.
2 Auditory Transformation—Incoming speech is transformed to match the user's vocal characteristics, including tone, cadence, and emotional resonance. Optional modes include ego-dissolution and accent normalization.

### Security and Ethical Safeguards

Tamper-Proof Hardware—Embedded sensors in glasses and headphones permanently disable the device upon unauthorized access.
Air-Gapped Operation with Blockchain Security—Offline-only architecture with embedded blockchain snapshots and zero-knowledge proof validation.
Guided, Time-Limited Use—Sessions are strictly controlled, with cooldown periods and instant removal mechanisms.
Adaptive Integration (Flame Memory Engine)—Stores only ethically validated experiences, aligned with forgiveness, empathy, and user consent.

This system is distinct from prior AR or auditory enhancement devices because it integrates perceptual empathy modulation, offline security, ethical constraints, and adaptive emotional calibration in a single wearable platform.

### DETAILED DESCRIPTION OF THE INVENTION

### 1. Hardware Structure

Glasses: Custom optical projection modules detect and transform faces to resemble the user, with progressive clarity adjustment. Embedded tamper sensors ensure security.
Headphones: AI audio processing chipsets transform all auditory input to the user's voice in real time, with directional microphone input and optional modes (ego-dissolution, accent normalization).
Integration: Glasses and headphones communicate via a secure offline protocol, ensuring synchronized visual and auditory transformations.

### 2. Perceptual Modification Technology

Visual: AI-driven facial recognition overlays faces to match the user. Haziness and progressive clarity prevent perceptual shock.
Auditory: Real-time voice modulation transforms speech to user's voice characteristics. Optional modes ensure emotional accuracy and bias reduction.

### 3. Security and Ethical Framework

Autonomous Continuous Evaluation (ACE): Offline ZKP-based evaluation engine validating system integrity, ethical alignment, and user state.
Flame Memory Engine: Stores session experiences only after ethical validation, including readiness and consent checks.
Offline, Air-Gapped Operation: No Wi-Fi, Bluetooth, or cloud connectivity.

### 4. User Experience and Safety Measures

Time-limited sessions with mandatory cooldown periods
Instant removal mechanism for immediate restoration of natural perception
Subtle adaptive guidance for emotional integration
Restricted access and consent-based deployment

### 5. Distinction From Prior Art

Unlike conventional AR or auditory devices, this invention uniquely combines:
Integrated visual and auditory empathy modulation
Offline, tamper-proof security architecture (ACE+blockchain+ZKP)
Adaptive ethical experience storage (Flame Memory)
Progressive perceptual adjustment to maintain psychological safety

### Methodology/Operation

### 1 Initialization

Power-on sequence triggers ACE validation, confirming offline blockchain snapshot integrity and Flame Memory readiness.
User authentication occurs through pre-registered biometrics (retinal scan).

### 2 Perceptual Transformation

Visual: Glasses detect faces, apply hazy overlay, progressively refine to full clarity.
Auditory: Headphones modulate voices to match user's characteristics; optional modes (ego-dissolution, accent normalization) apply.

### 3 Continuous Ethical Evaluation

ACE monitors user state against embedded world-state and ethical parameters.
Flame Memory validates session data before storage, ensuring alignment with empathy and forgiveness principles.

### 4 Session Management

Strict duration control with cooldown periods prevents emotional overload.
Instant removal mechanism immediately restores normal perception.

### 5 Updates (DUO)

Offline updates delivered via proprietary visual encoding.
Unit-tested and cryptographically validated before application.
Snapshot-aware intelligence ensures updates do not compromise system integrity or ethical alignment.

### Detailed Description of Implementation

### 1. Hardware Architecture

### 1.1 Glasses (Visual Module)

Optical Projection System: Custom AR projection modules overlay transformed faces onto the user's real-world view in real time.
Face Detection & Recognition: Embedded AI chip detects human faces, maps facial features, and generates visual overlays resembling the user.
Hazy Overlay & Progressive Clarity: Initial visual transformations are partially obscured; clarity increases according to user acclimation and cognitive comfort.
Tamper Sensors: Embedded sensors detect unauthorized access or modification attempts and permanently disable the device if triggered.
Secure Internal Bus: Communicates internally with headphones and processing units via encrypted, offline-only protocols.

### 1.2 Headphones (Auditory Module)

AI Voice Transformation Engine: Real-time modulation of detected speech to match user's tone, cadence, and emotional characteristics.
Directional Microphones & Acoustic Focus: Detect user auditory focus; adjust amplification and filtering for contextual accuracy.
Ego-Dissolution & Accent Normalization Modes: Optional settings to reduce emotional exaggeration and bias, enhancing empathetic resonance.
Tamper-Resistant Housing: Embedded sensors enforce device integrity and operational safety.

### 1.3 Integration & Internal Communication

Synchronized Perceptual Modifications: Glasses and headphones share internal signals to maintain alignment of visual and auditory transformations.
Secure Offline Protocols: Communication occurs solely within the device; no external networks or wireless transmission.

### 2. Perceptual Modification Engine

### 2.1 Visual Transformation

AI-driven facial recognition maps all detected faces to the user's features.
Dynamic hazy overlay prevents perceptual shock, with gradual clarity adjustment based on cognitive and emotional readiness.
Adjustable settings allow calibration of overlay strength and transition speed.

### 2.2 Auditory Transformation

Incoming audio is analyzed and modulated in real time to match the user's voice characteristics.
Optional Modes Include:
   Self-Voice Mapping: All voices perceived as user's own.
   Ego-Dissolution Mode: Neutralizes emotional exaggeration.
   Accent Normalization: Reduces subconscious bias due to regional or tonal differences.

### 2.3 Integration With Ace

Perceptual modifications are continuously evaluated against embedded world-state and ethical readiness.
Adjustments are made in real time to maintain cognitive and emotional safety.

### 3. ACE-Autonomous Continuous Evaluation

### 3.1 Embedded Blockchain Snapshot

Preloaded ledger and world-state data embedded at manufacture or initialization.
Provides offline trust anchor for continuous validation.

### 3.2 Zero-Knowledge Proof Engine

Evaluates user state, device integrity, and environmental input without revealing sensitive information externally.
Enables ethical readiness checks, cognitive safety validation, and authorization for session progression.

### 3.3 Evaluation Loop

Continuous comparison of real-time input (biometric, behavioral, auditory, visual) against embedded snapshot.
Triggers adaptive perceptual adjustments or safety interventions as needed.

### 4. Flame Memory Engine

Stores session experiences only after affirmative ethical validation.
Ensures recorded experiences align with forgiveness, empathy, and moral reflection principles.
Provides selective memory retention to prevent cognitive overload or unethical memory capture.

### 5. DUO—Device Update Orchestration

### 5.1 Proprietary Visual Encoding

Updates delivered via glyphs, spirals, or symbolic visual sequences.
Encodes encrypted update payloads, cryptographic signatures, and validation logic.

### 5.2 Offline, Air-Gapped Update Process

Device optical sensors read visual sequences; updates simulated in a secure sandbox.
Unit tests must pass before applying to live operational memory.
Replay protection, anti-tamper mechanisms, and optional self-destruct routines ensure integrity.

### 5.3 Snapshot-Aware Validation

Updates are checked against current ACE world-state to ensure contextual appropriateness.
Only verified and ethically aligned updates are applied.

### 6. User Experience & Safety Features

Time-Limited Sessions: Each session is restricted, followed by mandatory cooldown periods.
Instant Removal Mechanism: Removing glasses or headphones immediately restores natural perception.
Adaptive Guidance: Visual, auditory, or haptic cues provide feedback for emotional and ethical integration.
Ethical Deployment: Restricted to authorized users, with consent and readiness verification.

### Conclusion

The present invention represents a paradigm shift in human perceptual technology by unifying visual and auditory augmentation into a single, empathy-inducing wearable system. Unlike conventional augmented reality or auditory devices, this system does not merely overlay information or enhance sensory input; it transforms all perceived faces and voices to match the user, creating an immersive, self-reflective experience that fosters empathy, ethical engagement, and self-awareness.

Through the integration of tamper-proof hardware, offline blockchain authentication, Autonomous Continuous Evaluation (ACE), Device Update Orchestration (DUO), and ethical Flame Memory safeguards, the system ensures that every session aligns with principles of non-harm, consent, and emotional safety. Progressive acclimation, instant removal mechanisms, and controlled session durations further guarantee the cognitive and emotional integrity of the user.

This invention is distinct from conventional AR, auditory enhancement, and accessibility technologies, as it uniquely combines:
Integrated visual and auditory empathy modulation
Offline, tamper-resistant security architecture
Adaptive, ethics-based experience storage
Progressive perceptual adjustment to maintain psychological safety

The wearable empathy system is carefully calibrated to support ethical, secure, and transformative experiences, enabling users to develop enhanced empathy, forgiveness, and moral reflection. It provides a secure, self-contained, and ethically aligned platform for personal growth, social understanding, and compassionate human interaction, offering a novel and non-obvious solution to limitations of existing technologies.

In essence, this invention transforms the wearer's perception, allowing technology to serve as a mirror for ethical awareness, self-reflection, and human connection, providing a foundation for a new era of secure, conscious, and emotionally intelligent wearable devices.

1. Wearable Empathy System
A wearable empathy system, comprising:
(a) a pair of smart glasses configured to:
(i) detect human faces in real-time using embedded sensors;
(ii) generate a visual overlay transforming each detected face to resemble the user;
(iii) progressively adjust overlay clarity based on measurable acclimation parameters, including session duration, physiological indicators, and cognitive readiness;
(b) a pair of AI-powered headphones configured to:
(i) detect human voices in real-time;
(ii) modulate each detected voice to match the user's vocal characteristics, including tone, cadence, and emotional resonance;
(c) a tamper-resistant enclosure for both glasses and headphones, wherein embedded sensors permanently disable device functionality upon unauthorized access attempts;
(d) an offline blockchain authentication module for verifying device integrity and user authorization; and
(e) a perceptual modification engine that synchronizes visual and auditory transformations in real-time, interfaces with an Autonomous Continuous Evaluation (ACE) engine and a Flame Memory Engine, and outputs measurable indicators of induced empathy, self-awareness, and ethical engagement.

2. Dynamic Emotional and Ethical Adjustment
The system of claim 1, wherein the visual and auditory transformations are dynamically adjusted according to measured user parameters, including:
biometric signals (e.g., heart rate, EEG, galvanic skin response);
ethical readiness metrics determined via Flame Memory Engine evaluation; and
progressive acclimation profiles recorded during prior sessions.

3. Flame Memory Engine
The system of claim 1, further comprising a Flame Memory Engine that stores session experiences only upon ethical validation, including affirmative responses to binary ethical readiness questions and system-detectable alignment with measured user emotional and cognitive states.

4. Fully Offline Operation
The system of claim 1, wherein the smart glasses and AI-powered headphones operate entirely Offline, without Wi-Fi, Bluetooth, USB, NFC, or cloud connectivity, and all validation, monitoring, and session processing occur internally.

5. Autonomous Continuous Evaluation (ACE)
The system of claim 1, further comprising an Autonomous Continuous Evaluation (ACE) engine configured to:
(a) continuously monitor perceptual synchronization between visual and auditory channels;
(b) evaluate ethical and cognitive alignment of the user based on internal sensor inputs and Flame Memory Engine data;
(c) generate alerts or adjust perceptual outputs to maintain cognitive, emotional, and ethical safety; and
(d) perform all evaluations without transmitting any data externally.

6. Device Update Orchestration (DUO)
The system of claim 1, further comprising a Device Update Orchestration (DUO) module configured to:
(a) receive updates solely via proprietary visually encoded instructions, including non-standard glyphs, spirals, or vector-based symbols;
(b) cryptographically verify each update using embedded public keys;
(c) simulate and unit-test each update in a secure execution environment prior to application; and
(d) apply updates while maintaining full offline, air-gapped operation and tamper-proof integrity.

7. Session Management and Safety
The system of claim 1, wherein each user session is:
(a) time-limited according to pre-configured thresholds;
(b) followed by mandatory cooldown periods;
(c) subject to progressive perceptual adjustment based on real-time ACE monitoring; and
(d) immediately terminable by the user via removal of the glasses and/or headphones, restoring natural perception.

8. Immersive Empathy Induction
The system of claim 1, wherein the perceptual modification engine, in conjunction with ACE and Flame Memory, induces measurable empathetic responses in the user, facilitating:
(a) self-reflection and cognitive alignment;
(b) moral engagement and compassion; and
(c) ethical behavior reinforcement, without manipulation or harm.

9. Method of Inducing Empathy
A method of inducing empathetic perception in a user, comprising:
(a) detecting human faces and voices in the user's environment in real-time;
(b) transforming each detected face and voice to match the user's visual and auditory characteristics;
(c) verifying ethical readiness using binary evaluation questions processed by the Flame Memory Engine;
(d) storing session data only upon affirmative ethical validation and measurable alignment with ACE evaluation;
(e) maintaining full offline operation with tamper-proof security; and
(f) monitoring user state, session duration, and perceptual synchronization to ensure cognitive, emotional, and ethical safety.

10. Biometric Access Control
The system of claim 1, wherein access to the smart glasses and AI-powered headphones is restricted via biometric retinal scanning or equivalent biometric authentication, such that only authorized users with pre-registered retinal or biometric patterns can activate and operate the devices, ensuring controlled use and preventing unauthorized perceptual modification.
